(19) United States
(12) Patent Application Publication
(10) Pub. No.: US 2006/0130029 A1
(43) Pub. Date: Jun. 15, 2006

(54) Programming language model generating apparatus for hardware verification, programming language model generating method for hardware verification, computer system, hardware simulation method, control program and computer-readable storage medium

(75) Inventors: Takahiro Morishita, Nara (JP); Kazuhisa Okada, Nara (JP)

Correspondence Address: BIRCH STEWART KOLASCH & BIRCH, PO BOX 747, FALLS CHURCH, VA, 22040-0747, US

(73) Assignee: Sharp Kabushiki Kaisha, Osaka-shi (JP)

(21) Appl. No.: 11/272,712

(22) Filed: Nov. 15, 2005

(30) Foreign Application Priority Data
Nov. 15, 2004 (JP) 2004-331229

(51) Int. Cl. G06F 9/45

(52) U.S. Cl. 717/157

(57) ABSTRACT

The CDFG is generated by the CDFG generating section 109 based on the operation description of hardware 107, the CDFG is scheduled by the scheduling section 110 at an operation frequency required as the specification of the hardware and is assigned to each state, and the operation model of the hardware is generated by the cycle accurate model generating section 111 for each state as a description represented by a general-purpose programming language. The model which can be simulated for each state is generated by generating the operation model of each node using the operation information of the nodes included in the CDFG, and by determining the order in which the operation model of each node is calculated using the connection information of the nodes. As a result, it is possible to generate a model for verification described in a general-purpose programming language, which is capable of verifying hardware at a cycle accurate level at a lower cost and at a higher speed, with a smaller amount of calculation compared with the conventional method.

This Non provisional application claims priority under 35 U.S.C. §119(a) on Patent Application No.2004-331229 filed in Japan on Nov. 15, 2004, the entire contents of which are hereby incorporated by reference.

### BACKGROUND OF THE INVENTION

1. Field of the Invention

The present invention relates to a programming language model generating apparatus for hardware verification for automatically generating a general-purpose programming language description capable of verifying the hardware; a programming language model generating method for hardware verification using the apparatus; a computer system; a hardware simulation method using the computer system; a control program for making a computer execute the method; and a computer-readable storage medium having the control program stored thereon.

2. Description of the Related Art

In the development of a system LSI, it is necessary to verify whether or not the operation of a designed hardware satisfies the specification required for the system LSI.

Conventionally, a Hardware Description Language (HDL) simulator has been used to verify the hardware at a cycle accurate level. In this method, the HDL simulator measures performance such as an operation speed of hardware in order to verify whether or not the hardware satisfies the given specification. In general, the HDL simulator simulates a circuit operation described in a hardware description language such as VHDL. The HDL simulator monitors the change of the signals within the circuit at a time cycle which is shorter than the clock cycle and performs a simulation using an event-driven system for reflecting the change of the signals to a signal to be connected.

When the hardware described in a hardware description language and the software described in a general-purpose programming language are verified cooperatively, the hardware is debugged with an HDL simulator and the software with a software debugger or other debuggers. Furthermore, for example, Reference 1 discloses a method for simulating the operations of the hardware using a general-purpose programming language to cooperatively verify the hardware and the software. In this conventional technology, the hardware operating in parallel is represented by a general-purpose programming language, such as the C programming language, and this description is debugged by a software debugger. Thus, the efficiency of the cooperative verification of the hardware and the software is improved.

For example, Reference 2 discloses a method capable of performing a verification of the hardware at a cycle accurate level at a higher speed by generating a description indicating the operations of all calculations performed by the hardware with a higher-order synthesis and by generating a verification model in a general-purpose programming language. In this conventional technology, a control/data flow graph is divided for each state, and the operation information of each state is extracted. Then, the data path information is extracted by assigning the hardware to the divided control/data flow graph. A model verifiable at a cycle accurate level is generated by dividing operation units operating within each state for each operation condition based on the operation information and the data path information, and by determining the order in which the operation of each calculation is performed based on a level of the operation unit.

The term “cycle accurate level” is referred to as a level in accuracy capable of representing the state of the hardware in a unit of a clock cycle, with respect to the operation of the hardware. For example, in the hardware operating synchronously with a leading edge of a clock signal, the cycle accurate level is a level capable of representing a state of a storage device, such as a register or a memory, within the hardware at the leading edge of the clock signal.

The term “higher-order synthesis” is referred to as the technology for automatically generating a logic circuit at a register transfer level (RTL) based on the operation description which describes only the operations of the process, not including any information on the structure of the hardware. A detailed description can be found, for example, in Reference 3.

The term “state” is referred to as an operation performed for each clock cycle.

Reference 1: Japanese laid-open publication No. 10-149381

Reference 2 Japanese laid-open publication No. 2001-14356

Reference 3: Japanese laid-open publication No. 5-101141

However, the conventional technology described above provides the following problems.

In the verification using the HDL simulator described above, the simulation is performed in an event-driven system. As a result, a time unit for the simulation is shorter than a clock cycle. Accordingly, there is a problem that there are many redundant and unnecessary calculations and the efficiency of the calculation is poor in verifying the hardware at a cycle accurate level. Further, when the scale of a circuit to be simulated becomes large or the test pattern becomes long, a calculation amount required for the simulation is increased. This causes a problem that the time required for the simulation is increased. Further, there is a problem that the HDL simulator is expensive and the cost required for developing a system LSI is increased.

In the method for debugging the hardware described in a hardware description language with an HDL simulator and the software described in a general-purpose programming language with a software debugger when the hardware and the software are verified cooperatively, it is necessary to use debugger's in a different language. This causes a problem that the efficiency of the verification is reduced. Further, in the conventional technology disclosed in Reference 1, it is possible to perform a verification at an algorithm level, but impossible to perform a verification at a cycle accurate level. Accordingly, it is impossible to verify whether or not the hardware satisfies the specification required for the given system, such as an operation frequency.

In the conventional technology disclosed in Reference 2, when the scale of a circuit becomes large, a large amount of time is required for the allocation of the hardware and the extraction of the data path information, and an amount of calculation required for determining a level of the operation unit from the operation condition and determining an order of the calculations is increased. This causes a problem that the efficiency of the verification is reduced.

Thus, in the conventional technologies described above, there is a problem that TAT (turnaround time, i.e., the time required for turning back when a problem occurs and solving the problem) in designing and/or developing an LSI is prolonged and the cost required for the development is increased.

The present invention is provided to solve the conventional problems described above. The purpose of the present invention is to provide a programming language model generating apparatus for hardware verification suitable for designing and/or developing an LSI with the shorter TAT and the lower cost by generating a verification model described in a general-purpose programming language capable of verifying the hardware at a cycle accurate level at a lower cost and at a higher speed; a programming language model generating method for hardware verification using the apparatus; a computer system; a hardware simulation method using the computer system; a control program for making a computer execute the method; and a computer-readable storage medium having the control program stored thereon.

### SUMMARY OF THE INVENTION

According to one aspect of the invention, a programming language model generating apparatus for hardware verification is provided for automatically generating a general-purpose programming language model capable of verifying a hardware. The apparatus includes: a control data flow graph generating section for generating a control data flow graph of the hardware based on operation information obtained as a result of analyzing an operation description representing operations of the hardware; a scheduling section for scheduling the control data flow graph using an operating frequency required for the specification of the hardware, and for assigning the control data flow graph to each state; and a cycle accurate model generating section for generating an operation model of the hardware as a description represented by the general-purpose programming language using the control data flow graph assigned to each state.

In one embodiment of the invention, the cycle accurate model generating section includes: an operation model generating section for generating an operation model of each of a plurality of nodes included in the control data flow graph using an operation information of each of the nodes, and for determining an order in which the operation model of each of the nodes is calculated using a connection information of each of the nodes, in order to generate a model which can be simulated in each state.

In one embodiment of the invention, the cycle accurate model generating section includes: a register input value calculation formula generating section for generating a calculation formula used to store an output value of a particular node in the register using a model representing an output result of the particular node, when the output of the particular node is used as an input to another node over the states.

In one embodiment of the invention, the cycle accurate model generating section includes: a storage device input value calculation formula generating section for generating a calculation formula used to store an output value of a particular node or a register in the storage device using a model representing an output result of the particular node or the register, when the output of the particular node or the register is used as an input to the storage device.

In one embodiment of the invention, the cycle accurate model generating section represents the operation model of the hardware as a model which can be simulated in each state by using at least one function of the general-purpose programming language.

In one embodiment of the invention, the control data flow graph generating section includes: a syntactic/lexical analysis section for analyzing an operation description describing operations of a process, but not describing any structure of the hardware; a block division section for dividing a circuit into blocks in accordance with a parallel operation analyzed by the syntactic/lexical analysis section; and a control data flow graph generating section for generating, for each block, a control data flow graph including nodes each representing a calculation performed by the hardware and a branch representing a flow of data between the nodes.

In one embodiment of the invention, the operation information of each of the nodes includes, for each of the nodes: information indicating at least whether or not the node represents a calculation, a type of the calculation to be performed when the node represents the calculation, a function of the node when the node does not represent any calculation; a hierarchal level; and a state number.

In one embodiment of the invention, the connection information of each of the nodes includes information indicating destinations of the output and the input of the node.

According to another aspect of the invention, a computer system is provided. The computer system includes: a programming language model generating apparatus for hardware verification according to claim 1; and a simulation section for simulating the hardware by executing at least one function generated by the cycle accurate model generating section, in accordance with an order of the states to be executed, which is obtained as the scheduling result by the scheduling section.

According to another aspect of the invention, a programming language model generating method for hardware verification is provided for automatically generating a general-purpose programming language model capable of verifying a hardware. The method includes the steps of: (a) generating a control data flow graph of the hardware based on operation information obtained as a result of analyzing an operation description representing operations of the hardware; (b) scheduling the control data flow graph using an operating frequency required for the specification of the hardware, and for assigning the control data flow graph to each state; and (c) generating an operation model of the hardware as a description represented by the general-purpose programming language using the control data flow graph assigned to each state.

In one embodiment of the invention, the step (c) includes the step of: generating an operation model of each of a plurality of nodes included in the control data flow graph using an operation information of each of the nodes, and for determining an order in which the operation model of each of the nodes is calculated using a connection information of each of the nodes, in order to generate a model which can be simulated in each state.

In one embodiment of the invention, the step (c) includes the step of: generating a calculation formula used to store an output value of a particular node in the register using a model representing an output result of the particular node, when the output of the particular node is used as an input to another node over the states.

In one embodiment of the invention, the step (c) includes the step of: generating a calculation formula used to store an output value of a particular node or a register in the storage device using a model representing an output result of the particular node or the register, when the output of the particular node or the register is used as an input to the storage device.

In one embodiment of the invention, the step (c) includes the step of: representing the operation model of the hardware as a model which can be simulated in each state by using at least one function of the general-purpose programming language.

In one embodiment of the invention, the step (a) includes the steps of: analyzing an operation description describing operations of a process, but not describing any structure of the hardware; dividing a circuit into blocks in accordance with a parallel operation analyzed by the syntactic/lexical analysis section; and generating, for each block, a control data flow graph including nodes each representing a calculation performed by the hardware and a branch representing a flow of data between the nodes.

According to another aspect of the invention, a hardware simulation method is provided. The method includes: the steps of the programming language model generating method for hardware verification described above; and a simulation step of simulating the hardware by executing at least one function generated in the step (c), in accordance with an order of the states to be executed, which is obtained as the scheduling result in the step (b).

According to another aspect of the invention, a control program is provided for making a computer execute the steps of the method described above.

According to another aspect of the invention, a computer-readable storage medium is provided. The computer-readable storage medium has stored thereon the control program described above.

The functions of the present invention will be described below.

According to the present invention, a control/data flow graph is generated based on the operation description of hardware, the control/data flow graph is scheduled at an operation frequency required as the specification of the hardware and is assigned to each state. An operation model of the hardware is generated using the control/data flow graph for each state as a description represented by a general-purpose programming language.

It is possible to generate a model which can be simulated for each state by generating an operation model of each node using the operation information of each node included in the control/data flow graph and by determining an order in which the operation model of each node is calculated using the connection information of each node. Further, it is possible to simulate the hardware at a cycle accurate level by representing a model which can be simulated for each state using a function described in a general-purpose programming language and by performing the function in accordance with the order to be executed, which is obtained as the scheduling result.

It is possible to calculate an input value to a register for each state by generating a calculation formula used to store an output value of a node in the register using a model representing an output result of the node, when the output of the node is used as an input to another node over the states. Further, it is possible to observe the state of a register at an arbitrary clock cycle, which is realized by a flip-flop and so forth, within the hardware by performing an assigning process to the hardware.

It is possible to calculate an input value to a storage device for each state by generating a calculation formula used to store an output value of a node or a register in the storage device using a model representing an output result of the node or the register, when the output of the node or the register is used as an input to the storage device. Further, it is possible to observe the state of a storage device at an arbitrary clock cycle, which is realized by a memory and so forth, within the hardware by performing an assigning process to the hardware.

As described above, according to the present invention, it is possible to verify the hardware at a cycle accurate level at a lower cost and at a higher speed, compared to verification using a conventional HDL simulator. Further, when the verification of hardware and software is performed cooperatively, the verification of the hardware can be performed using a model described in a general-purpose programming language. Accordingly, it is possible to efficiently perform the verification at a cycle accurate level without using any debugger in the different language.

According to the present invention, it is possible to improve the efficiency of debugging the hardware by observing the state of the registers and the storage device within the hardware at an arbitrary clock cycle.

According to the present invention, a model is generated using the control/data flow graph. It is not necessary to generate data path information which is performed after the scheduling process is completed in a higher-order synthesis process. Accordingly, it is possible to greatly reduce the computing time required for generating an operation model, even when the scale of the circuit becomes large.

As described above, according to the present invention, it is possible to shorten the TAT for designing and/or developing an LSI and to reduce the cost required for the development.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram showing an exemplary configuration of a computer system used to implement a programming language model generating apparatus for hardware verification according to an embodiment of the present invention.

FIG. 2 is a flowchart showing an exemplary procedure of a programming language model generating method for hardware verification according to an embodiment of the present invention.

FIG. 3 is a diagram showing an example of a CDFG for explaining the procedure of generating a calculation formula used to calculate an input value to a register in the programming language model generating method for hardware verification according to an embodiment of the present invention.

FIG. 4 is a diagram showing an example of operation information for each node of the CDFG shown in FIG. 3.

FIG. 5 is a diagram showing an example of connection information for each node of the CDFG shown in FIG. 3.

FIG. 6 is a diagram showing an example of an operation model for each node, which is generated by the operation model generating section shown in FIG. 2 using the operation information of each node shown in FIG. 4.

FIG. 7 is a diagram showing an example of calculation formulae of the input values to the registers to be updated, which are generated by the register input value calculation formula generating section shown in FIG. 2 using the connection information of each node shown in FIG. 5, over the delimiter 313 of the states shown in FIG. 3.

FIG. 8 is a diagram showing an example of calculation formulae of the input values to the registers to be updated, which are generated by the register input value calculation formula generating section shown in FIG. 2 using the connection information of each node shown in FIG. 5, over the delimiter 314 of the states shown in FIG. 3.

FIG. 9 is a diagram showing an example of calculation formulae of the input values to the registers to be updated, which are generated by the register input value calculation formula generating section shown in FIG. 2 using the connection information of each node shown in FIG. 5, over the delimiter 315 of the states shown in FIG. 3.

FIG. 10 is a diagram showing an example of the C programming language description, which describes the calculation formulae shown in FIGS. 6 to 9 in the function “STATE_n_func” for the state number n shown in FIG. 3.

FIG. 11 is a diagram showing an example of the C programming language description, which describes the calculation formulae shown in FIGS. 6 to 9 in the function “STATE_n1_func” for the state number n+1 shown in FIG. 3.

FIG. 12 is a diagram showing an example of the C programming language description, which describes the calculation formulae shown in FIGS. 6 to 9 in the function “STATE_n2_func” for the state number n+2 shown in FIG. 3.

FIG. 13 is a diagram showing an example of a CDFG for explaining the procedure of generating a calculation formula used to calculate an input value to a storage device such as a memory in the programming language model generating method for hardware verification according to an embodiment of the present invention.

FIG. 14 is a diagram showing an example of operation information for each node of the CDFG shown in FIG. 13.

FIG. 15 is a diagram showing an example of connection information for each node of the CDFG shown in FIG. 13.

FIG. 16 is a diagram showing an example of an operation model for each node, which is generated by the operation model generating section shown in FIG. 2 using the operation information of each node shown in FIG. 14.

FIG. 17 is a diagram showing an example of the C programming language description, which describes the calculation formulae shown in FIG. 16 in the function “STATE_n_func” for the state number n shown in FIG. 13.

FIG. 18 shows an example of the arbitration processing for arbitrating the write operations of the plurality of function blocks.

FIG. 19 is a diagram showing an example of a modified version of the description shown in FIG. 17 when the arbitration processing is required to write data into a storage device such as a memory.

FIG. 20 is a diagram showing an example of a processing performed by the arbitration processing section shown in FIG. 18.

### DESCRIPTION OF THE PREFERRED EMBODIMENTS

The following describes in detail an embodiment of a programming language model generating apparatus for hardware verification and a programming language model generating method for hardware verification according to the present invention, with reference to the drawings.

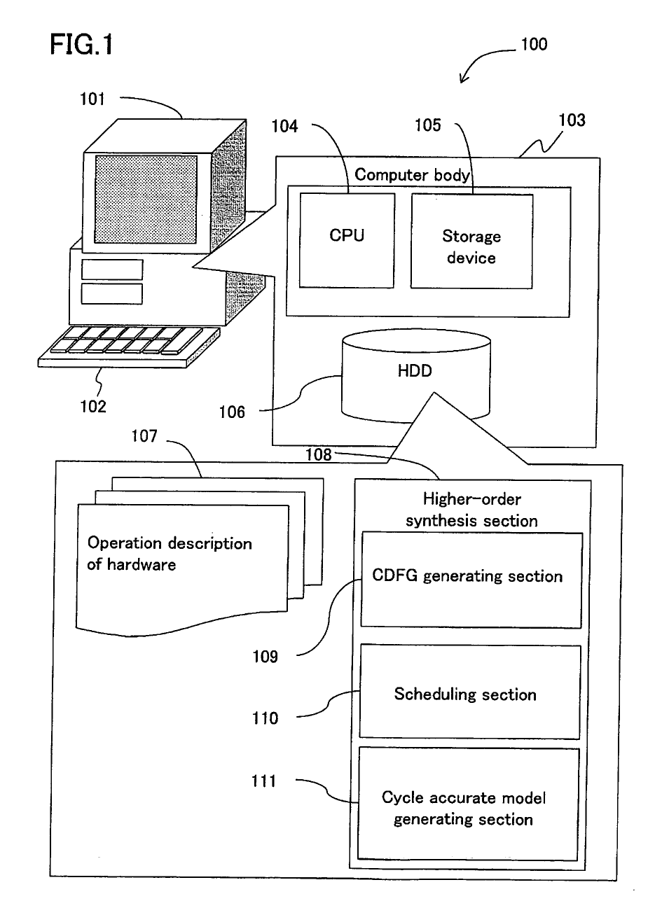

FIG. 1 shows an exemplary configuration of a computer system used to implement a programming language model generating apparatus for hardware verification according to an embodiment of the present invention.

In FIG. 1, a computer system 100 functions as a programming language model generating apparatus for hardware verification. The computer system 100 includes a monitor device 101 as an output device, an input device 102 such as a keyboard, and a computer body 103. The computer body 103 includes a CPU (Central Processing Unit) 104 as a control section, a storage device 105 such as a work memory, and a computer-readable storage medium 106 such as a magnetic disc (e.g. FD), an optical disc (e.g. CD) and a hard disc (e.g. HDD). In this example, the HDD is used as the computer-readable storage medium 106.

The HDD 106 stores an operation description of hardware 107 and a higher-order synthesis section 108. The higher-order synthesis section 108 includes a programming language model generating program for hardware verification, which describes a procedure for performing, using a computer, the operations of the programming language model generating apparatus for hardware verification according to the present embodiment, and a control program such as a simulation program. These programs are read from the HDD 106 to the work memory of the storage device 105 when the computer is initiated, and the programs are executed by the CPU 104.

The higher-order synthesis section 108 includes a CDFD generating section 109 for generating a control data flow graph (hereinafter, “CDFG”) of the hardware using a higher-order synthesis method, based on operation information obtained as a result of analyzing an operation description representing operations of the hardware; a scheduling section 110 for scheduling the CDFG using an operating frequency required for the specification of the hardware and for assigning the CDFD to each state; and a cycle accurate model generating section 111 for generating an operation model capable of verifying the hardware at a cycle accurate level as a description represented by a general-purpose programming language using the CDFG assigned to each state.

The computer system 100 further includes a simulation section (not shown) for simulating the hardware by the CPU 104 executing at least one function generated by the cycle accurate model generating section 111 in accordance with an order of the states to be executed. The order of the states is obtained as the scheduling result by the scheduling section 110 based on the control program included in the higher-order synthesis section 108.

The higher-order synthesis method is described in detail in Reference 3, and therefore the detailed description thereof will be omitted herein. In the present embodiment, it is assumed that the parallel operation of the circuit can be described using the higher-order synthesis method. Further, it is assumed that the model capable of verifying the hardware at a cycle accurate level generated in the present embodiment is described using the C programming language, which is a general-purpose programming language.

A programming language model generating method for hardware verification according to the present embodiment will be described below with reference to the configuration of the computer system 100.

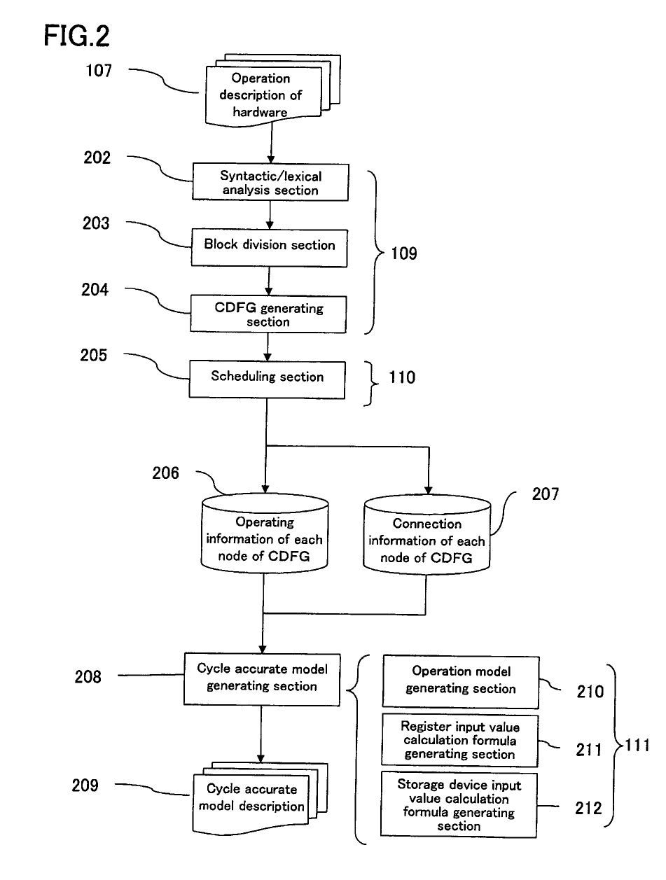

FIG. 2 shows an exemplary procedure of a programming language model generating method for hardware verification according to an embodiment.

As shown in FIG. 2, the CDFG generating section 109 shown in FIG. 1 includes a syntactic/lexical analysis section 202 for analyzing the operation description of hardware 107: a block division section 203 for dividing a circuit into a plurality of blocks in accordance with a description of the parallel operation analyzed by the syntactic/lexical analysis section 202; and a CDFG generating section 204 for generating the CDFG for each block divided by the block division section 203.

The scheduling section 205 schedules the CDFG using the operating frequency given as the specification of the hardware, and assigns the CDFG to each state. The scheduling section 110 shown in FIG. 1 includes the scheduling section 205.

The cycle accurate model generating section 208 includes an operation model generating section 210; a register input value calculation formula generating section 211; and a storage device input value calculation formula generating section 212. The cycle accurate model generating section 111 shown in FIG. 1 includes the cycle accurate model generating section 208.

The operation model generating section 210 generates an operation model of each node included in the CDFG using the operation information of each node, and determines an order in which the operation model of each node is calculated using the connection information of each node. The determination of the order in which the operation model of each node is calculated includes determining a level of each node using the information on the connection destination of the input of the each node and/or the connection destination of the output of each node, and sorting the nodes in an ascending order of the levels (i.e. an order from the lowest level to the highest level).

The register input value calculation formula generating section 211 generates a calculation formula used to store an output value of a node in the register using a model representing an output result of the node, when the output of the node is used as an input to another node over the states.

The storage device input value calculation formula generating section 212 generates a calculation formula used to store an output value of a node or a register in a storage device using a model representing an output result of the node or the register, when the output of the node or the register is used as an input to the storage device such as a memory.

Thus, the operation description of hardware 107 is analyzed by the syntactic/lexical analysis section 202. Then, a circuit is divided into a plurality of blocks by the block division section 203 in accordance with the description of parallel operation. For each block, a CDFG is generated by the CDFG generation section 204. The CDFG represents the operations of the hardware using a plurality of nodes and at least one branch connecting at least two of the nodes. Herein, each node represents a calculation or other operation performed within the hardware, and each branch represents a flow of data between the nodes. The data output from a node is transferred through a branch connected to the node, and the transferred data is used as an input to another node which is connected to the node via the branch.

The scheduling section 205 schedules each node of the CDFG such that a circuit can be operated at an operation frequency given to the hardware. As a result of the scheduling, operation information 206 such as information on a state where a calculation is made, and connection information 207 defining connection of a node to another node, are generated for each node of the CDFG. The connection information 207 of each node of the CDFG further includes information indicating whether or not the input and/or output of the node is connected to a register.

Using the operation information 206 and the connection information 207, a description 209 is generated by the cycle accurate model generating section 208. The description 209 describes a model capable of verifying (simulating) the hardware at a cycle accurate level using a general-purpose programming language.

Further, the CPU 104 can simulate the hardware by executing the description 209 (function) generated by the cycle accurate model generating section 208, in accordance with an order of the states to be executed. The order of the states is obtained as the scheduling result by the scheduling section 205 based on the control program included in the higher-order synthesis section 108.

Hereinafter, the operations of the cycle accurate model generating section 208 will be described in detail. Specifically, the operation of generating a model representing a calculation operation for each state of the CDFG which is scheduled by the operation model generating section 210; the operation of generating a calculation formula used to obtain an input value to a register by the register input value calculation formula generating section 211; and the operation of generating a calculation formula used to obtain an input value to a storage device such as a memory by the storage device input value calculation formula generating section 212, will be described in detail below.

Firstly, an example of the operation of generating an operation model of each node included in the CDFG using the operation information of each node, and determining an order in which the operation model of each node is calculated using the connection information of each node, is described. This operation is performed by the operation model generating section 210. Then, an example of the operation of generating a calculation formula used to store an output value of a node in a register using a model representing an output result of the node, when the output of the node is used as an input to another node over the states, is described. This operation is performed by the register input value calculation formula generating section 211.

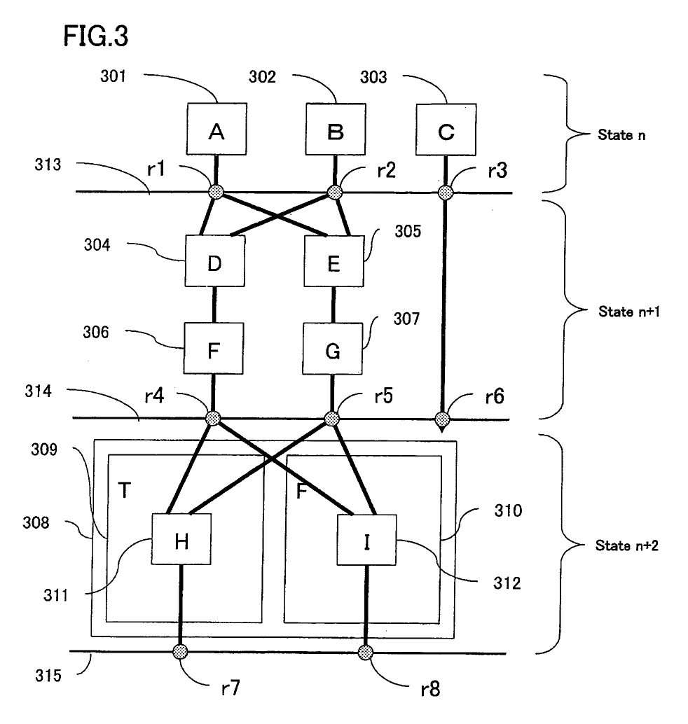

FIG. 3 shows an example of the CDFG for explaining the procedure of generating a calculation formula used to calculate an input value to a register in the programming language model generating method for hardware verification according to the present embodiment.

In FIG. 3, the CDFG includes: a node 301 for performing a calculation “A”; a node 302 for performing a calculation “B”; a node 303 for performing a calculation “C”; a node 304 for performing a calculation “D”: a node 305 for performing a calculation “E”; a node 306 for performing a calculation “F”; a node 307 for performing a calculation “G”; a branch node 308 having two internal nodes (i.e. true (T) and false (F)), to one of which the process proceeds depending on a condition; a node 309 for operating within the branch node 308 when the condition is true (T); a node 310 for operating within the branch node 308 when the condition is false (F); a node 311 for performing a calculation “H”; and anode 312 for performing a calculation “I”.

These nodes are delimited by the delimiter 313 and the delimlter 314. These delimiters are used to determine a boundary between the states. These delimiters are determined to conform with the delimiters of the operation clock of the hardware. Nodes 301 to 303 are included in state n, nodes 304 to 307 are included in state n+1, and nodes 308 to 312 are included in state n+2.

When the state is changed by the progress of the clock, there is a case where a register is required for storing an output result of a node. In the example shown in FIG. 3, r1 to r8 each denote a register for storing an output result of a node.

For example, the output result of node 301 is stored in register r1. The output result stored in register r1 is used as an input to nodes 304 and 305 over the delimiter 313 of the states. The output result of node 302 is stored in register r2. The output result stored in register r2 is used as an input to nodes 304 and 305 over the delimiter 313 of the states. The output result of node 303 is stored in register r3. The output result stored in register r3 is used as an input to register r6 over the delimiter 313 of the states. The output result of node 306 is stored in register r4. The output result stored in register r4 is used as an input to one of nodes 311 and 312 over the delimiter 314 of the states. The output result of node 307 is stored in register r5. The output result stored in register r5 is used as an input to one of nodes 311 and 312 over the delimiter 314 of the states. The output result of node 311 is stored in register r7. The output result of node 312 is stored in register r8.

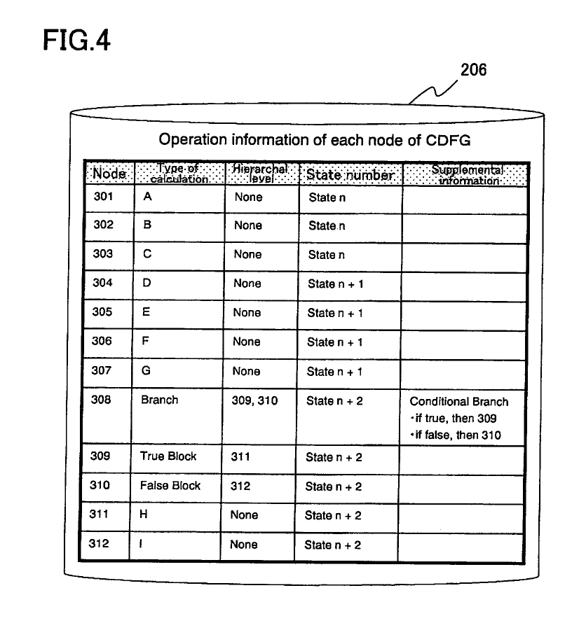

FIG. 4 shows an example of operation information 206 for each node of the CDFG shown in FIG. 3. The operation information 206 includes, for each node, a type of calculation, a hierarchal level, a state number and supplemental information. The type of calculation indicates whether or not the node represents a calculation, a type of the calculation to be performed when the node represents the calculation, and a function of the node when the node does not represent any calculation.

As shown in FIG. 4, nodes 301, 302, 303, 304, 305, 306, 307, 311 and 312 are calculation nodes which perform calculations “A”, “B”, “C”, “D”, “E”, “F”, “G”, “H” and “I”, respectively.

Nodes 308, 309 and 310 are not calculation nodes, but are nodes having a hierarchal structure. Node 308 is a branch node (Branch) having two nodes (i.e. nodes 309 and 310) within node 308. Node 309 is a true block (True Block) having node 311 within node 309. Node 310 is a false block (False Block) having node 312 within node 310. Such information on the hierarchical structure is also one type of operation information of the node.

The information on the states in which each node operates is also included in the operation information 206. For example, nodes 301 to 303 are scheduled for state number “n”, nodes 304 to 307 are scheduled for state number “n+1”, and nodes 308 to 312 for state number “n+2”.

Further, for nodes having conditional branch such as node 308, the operation information 206 includes information on a destination of the branch as the supplemental information. When it is determined that the condition in node 308 is “true”, then the process branches from node 308 to node 309. When it is determined that the condition in node 308 is “false”, then the process branches from node 308 to node 310.

FIG. 5 shows an example of the connection information 207 for each node of the CDFG shown in FIG. 3. The connection information 207 includes information indicating a connection destination of the input of the node and/or a connection destination of the output of the node, for example.

As shown in FIG. 5, the connection destination of the output of each of nodes 301, 302, 303, 306, 307, 311 and 312 is indicated by a register. In this case, the connection destination is identified by the name of the register.

The connection destination of the output of each of nodes 304 and 305 is indicated by a node other than nodes 304 and 305. The connection destination is identified by the name of the node.

In a similar manner, the connection destination of the input of each node is indicated by a node or a register.

For example, nodes 304 and 305 each have two inputs (i.e. input 1 and input 2). The value stored in register r1 is input to the input 1 of nodes 304 and 305. The value stored in register r2 is input to the input 2 of nodes 304 and 305. Node 306 has a single input. The value of node 304 is input to node 306. Node 307 has a single input. The value of node 305 is input to node 307. Node 308 has a single input. The value stored in register r6 is input to node 308. Nodes 311 and 312 each have two inputs (i.e. input 1 and input 2). The value stored in register r4 is input to the input 1 of nodes 311 and 312. The value stored in register r5 is input to the input 2 of nodes 311 and 312.

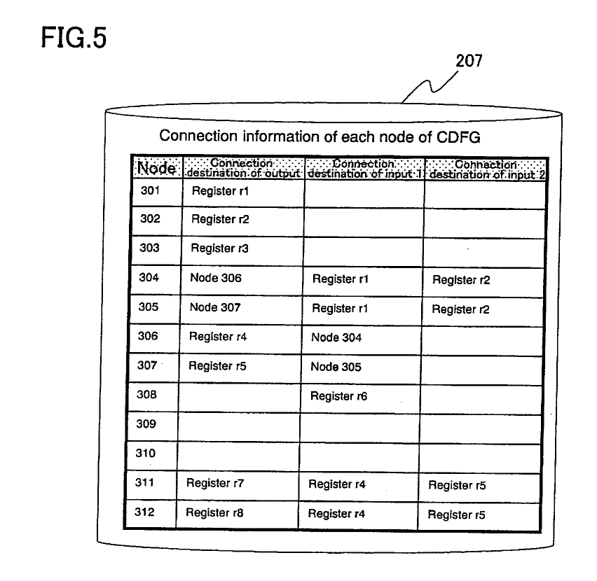

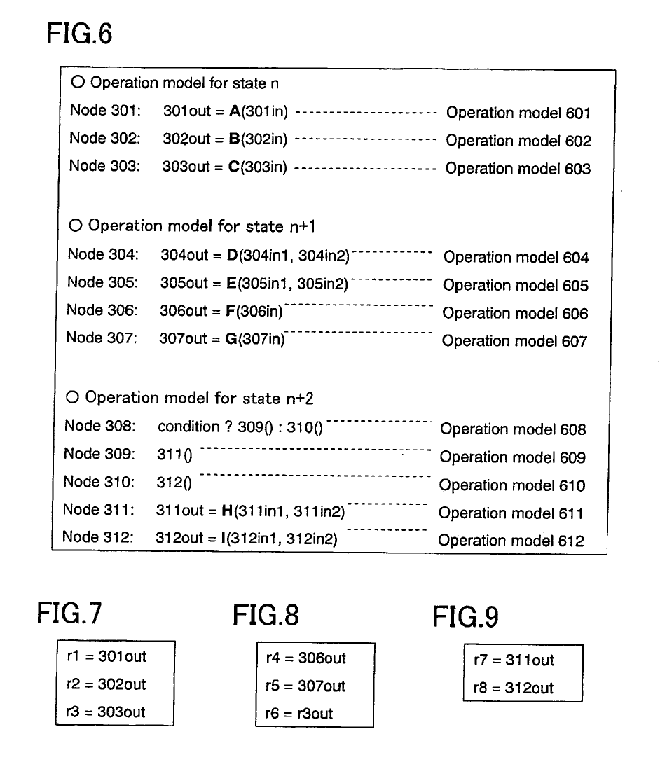

FIG. 6 shows an example of an operation model for each node, which is generated by the operation model generating section 210 shown in FIG. 2 using the operation information 206 of each node shown in FIG. 4.

In the operation model shown in FIG. 6, the suffix “in” and the suffix “out” are used in order to distinguishably indicate the input value and the output value of each node. The suffix “in” of the node number is used to indicate an input value to the node identified by the node number. The suffix “out” of the node number is used to indicate an output value from the node identified by the node number. For example, “301in” denotes the input value to node 301. When there are two input values, the suffixes “in1” and “in2” are used.

In the operation model shown in FIG. 6, “A”, “B”, “C”, “D”, “E”, “F”, “G”, “H” and “I” each indicate a type of calculation for each node which performs the calculation.

For example, the operation model of node 304 indicates that calculation “D” is performed with respect to input value “304in1” and input value “304in2”. Specifically, if calculation “D” is an addition, then the operation model is represented by the equation of “304out=304in1+304 in2” using an operator “+” for performing an addition in the C programming language.

The operation model of node 308, which is an example of the node which performs function other than a calculation, indicates that one of function “309( )”and function “310( )” is selectively performed in accordance with the determination result of the condition. Function “309( )” indicates an operation of node 309 within node 308, which is described by the C programming language. Function “310( )” indicates an operation of node 310 within node 308, which is described by the C programming language. The operation model of node 308 is represented by a ternary operator of the C programming language.

The operation model of node 309 indicates that function “311( )” is performed. Function “311( )” indicates an operation of node 311 within node 309, which is described by the C programming language.

The operation model of node 310 indicates that function “312( )” is performed. Function “312( )” indicates an operation of node 312 within node 310, which is described by the C programming language.

Next, a method for determining an order in which the operation model for each node is calculated will be described. The order is determined for each state. The order is determined by the operation model generating section 210 shown in FIG. 2. The order is determined by determining a level of each node using the connection information 207 of each node, and by sorting the nodes in an ascending order of the levels (i.e. an order from the lowest level to the highest level).

The procedure of determining a level of each node is as follows:

(1) The level of all nodes is set to zero;

(2) A destination node which is connected to the output of a node is extracted from the connection information of the node;

(3) The level of the destination node is set to a value obtained by adding “+1” to the maximum value of the levels of all nodes which are input to the destination node.

By applying steps (2) and (3) to all nodes in a state, the determination of a level of each node in a state is completed. When the node has a hierarchal structure, a level of each node in the hierarchal structure is determined in accordance with the procedure described above.

According to the procedure described above, a level of each node is determined in each state. In the example shown in FIG. 3, the levels of nodes 301, 302 and 303 in state n are determined as being the same level. This is because there is no node in state n, which is connected to the outputs of nodes 301, 302 and 303. Accordingly, the operation model can be calculated from any one of nodes 301, 302 and 303.

In state n+1, the output of node 304 is connected to node 306. Accordingly, when the level of node 304 is set to a value of “0”, the level of node 306 is updated to a value of “1”. Accordingly, the operation model of node 306 is calculated after the operation model of node 304 is calculated. Similarly, the output of node 305 is connected to node 307. Accordingly, the operation model of node 307 is calculated after the operation model of node 305 is calculated.

In state n+2, only the operation model of node 308 having the hierarchal structure is calculated.

FIG. 7 shows an example of calculation formulae of the input values to the registers to be updated, which are generated by the register input value calculation formula generating section 211 shown in FIG. 2 using the connection information 207 of each node shown in FIG. 5, over the delimiter 313 of the states shown in FIG. 3.

In the procedure of generating calculation formulae, the nodes assigned to state n are extracted from the operation information 206 of each node of the CDFG. As a result of the extraction, nodes 301, 302 and 303 are obtained.

Next, the nodes having the output which is connected to a register are extracted from the connection information 207 of each node of the CDFG. As a result of the extraction, the information indicating that the output of node 301 is connected to register r1, the output of node 302 is connected to register r2, and the output of node 303 is connected to register r3 is obtained.

Next, a model for setting the output value of a node or a register connected to the register to the register is generated. As a result of generating the model, calculation formulae of the input values to the registers are generated such that the output value of node 301 is input to register r1, the output value of node 302 is input to register r2, and the output value of node 303 is input to register r3, respectively.

FIG. 8 shows an example of calculation formulae of the input values to the registers to be updated, which are generated by the register input value calculation formula generating section 211 shown in FIG. 2 using the connection information 207 of each node shown in FIG. 5, over the delimiter 314 of the states shown in FIG. 3.

The procedure of generating calculation formulae is the same as the procedure described above over the delimiter 313 of the states. As a result of the generation, calculation formulae of the input values of the registers are generated such that the output value of node 306 is input to register r4, the output value of node 307 is input to register r5, and the output value of register r3 is input to register r6, respectively. The calculation formula of the input value to register r6 is represented by “r6=r3out”. This calculation formula indicates that the output value of register r3 is input to register r6.

FIG. 9 shows an example of calculation formulae of the input values to the registers to be updated, which are generated by the register input value calculation formula generating section 211 shown in FIG. 2 using the connection information 207 of each node shown in FIG. 5, over the delimiter 315 of the states shown in FIG. 3.

The procedure of generating calculation formulae is the same as the procedure described above over the delimiter 314 of the states. As a result of the generation, calculation formulae of the input values of the registers are generated such that the output value of node 311 is input to register r7, and the output value of node 312 is input to register r8.

According to the connection information 207 of each node shown in FIG. 5, the output of node 311 is connected to register r7 and the output of node 312 is connected to register r8. Further, when the operation information 206 of each node shown in FIG. 4 is checked in view of the hierarchal structure of nodes 311 and 312, it will be seen that node 311 is included in the hierarchal level of node 309 and node 312 is included in the hierarchal level of node 310. Nodes 309 and 310 are included in the hierarchal level of node 308 having an operation condition. Based on the information above, it is understood that data is input into only one of registers r7 and r8 in accordance with the operation condition of node 308.

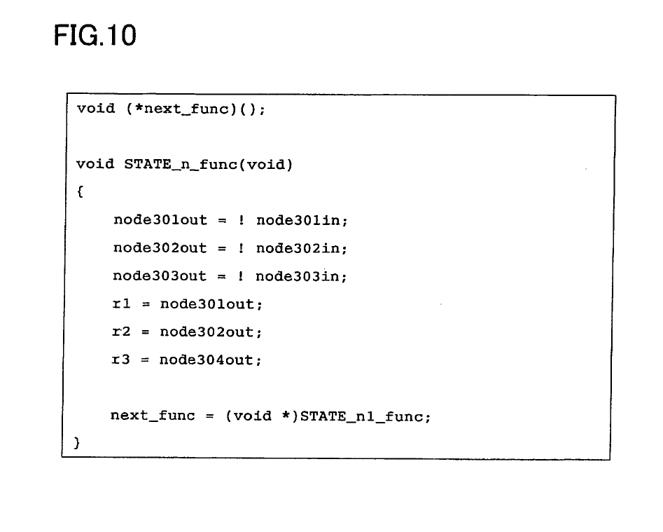

FIG. 10 shows an example of the C programming language description, which describes the calculation formulae shown in FIGS. 6 to 9 in the function “STATE_n_func” for state number n shown in FIG. 3.

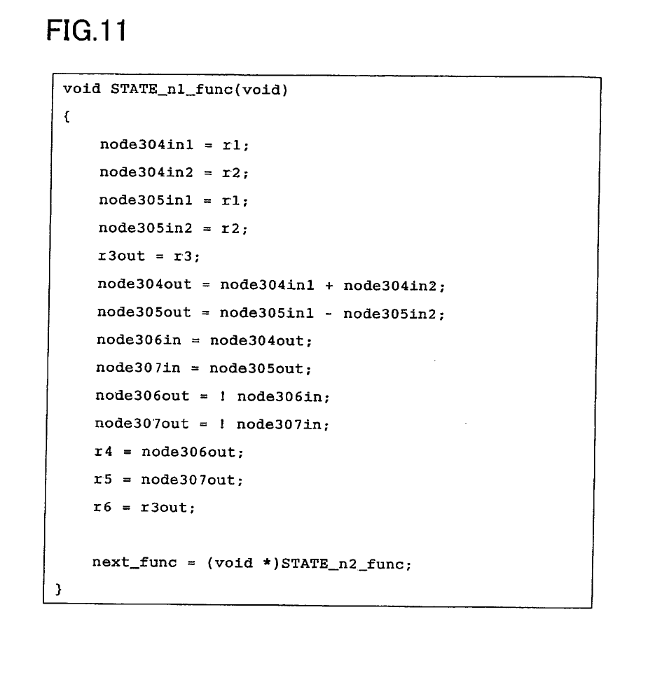

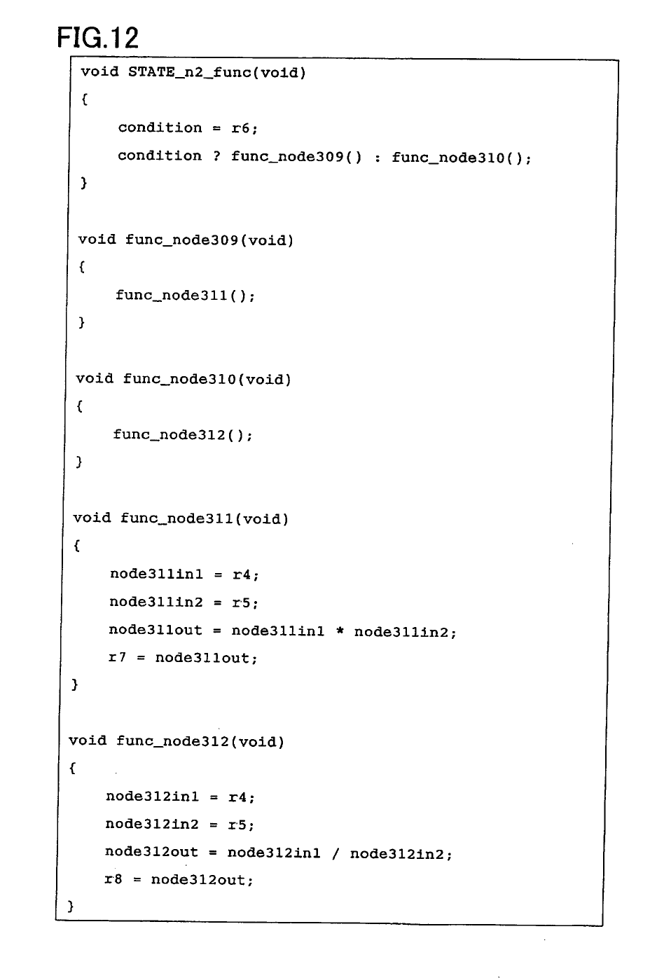

In the example shown in FIG. 10, the NOT operation “!” is performed for each of the nodes 301, 302 and 303. The variables representing the input value and output value of the node are expressed as “node301in”, “node301out”. The same expression is used in the calculation formulae shown in FIGS. 11 and 12.

In FIGS. 10 to 12, when an output value of a node is used as an input value to another node over the states, the output value of the node is input to a register using a calculation formula for calculating an input value to the register.

In the examples shown in FIG. 10 to 12, a pointer to the function “next_func” is defined, and the function to be executed in the next state is registered using this pointer. In a circuit simulation using a model generated by the present embodiment, the simulation cycle may be progressed one by one by executing the function “next_func”.

FIG. 11 shows an example of the C programming language description, which describes the calculation formulae shown in FIGS. 6 to 9 in the function “STATE_n1_func” for state number n+1 shown in FIG. 3.

In the example shown in FIG. 11, the addition is performed for node 304, the subtraction is performed for node 305, and the NOT operation “!” is performed for each of nodes 306 and 307.

FIG. 12 shows an example of the C programming language description, which describes the calculation formulae shown in FIGS. 6 to 9 in the function “STATE_n2_func” for state number n+2 shown in FIG. 3. In the present embodiment, in state number n+2, it is determined whether performing the operation of node 309 or the operation of node 310 is selected by the value stored in register r6.

In the example shown in FIG. 12, the operations of nodes 309 and 310 are represented as individual functions.

In the function “func_node309” of node 309, the operation of node 311 included in the hierarchal level of node 309 is performed. The operation of node 311 is represented by the function “func_node311”. In the example shown in FIG. 12, a multiplication is performed in the function “func_node311”.

In the function “func_node312” of node 310, the operation of node 312 included in the hierarchal level of node 310 is performed. The operation of node 312 is represented by the function “func_node312”. In the example shown in FIG. 12, a division is performed in the function “func_node312”.

As described above, it is possible to calculate an input value to a register for each state in the CDFG after the scheduling process is completed, by using the C programming language description shown in FIGS. 10 to 12.

Further, it is possible to simulate the hardware at a cycle accurate level by performing at least one function generated by the cycle accurate model generating section 111, in accordance with the order to be executed, which is obtained as the scheduling result.

Further, it is possible to observe the values of the registers, which are realized by flip-flops and so forth, within the hardware at a cycle accurate level by performing an assigning process to the hardware.

Next, an example of the operation of generating an operation model of each node included in the CDFG using the operation information 206 of each node, and determining an order in which the operation model of each node is calculated using the connection information 207 of each node, is described. This operation is performed by the operation model generating section 210. Then, an example of the operation of generating a calculation formula used to store an output value of a node or a register in a storage device using a model representing an output result of the node or the register, when the output of the node or the register is used as an input to the storage device such as a memory, is described. This operation is performed by the storage device input value calculation formula generating section 212.

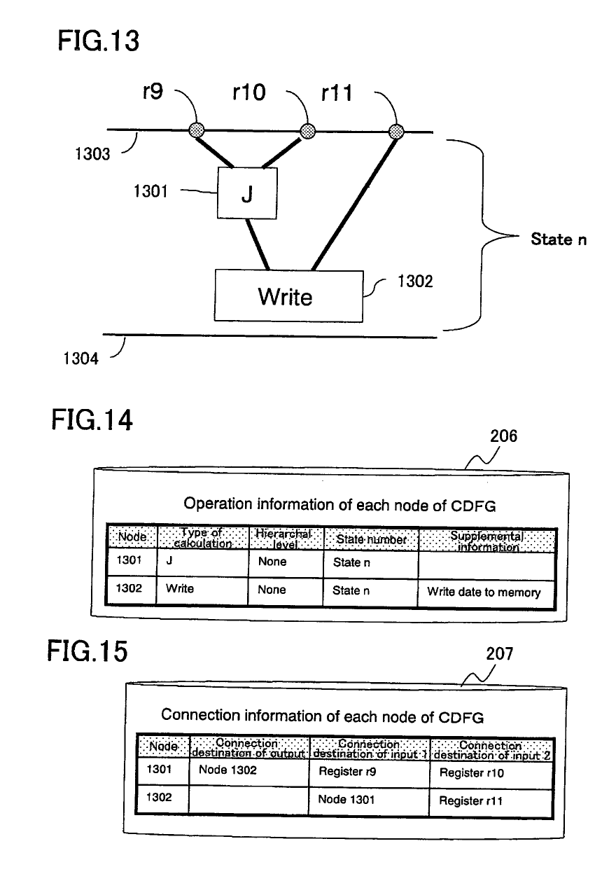

FIG. 13 shows an example of the CDFG for explaining the procedure of generating a calculation formula used to calculate an input value to a storage device such as a memory in the programming language model generating method for hardware verification according to an embodiment.

In the example shown in FIG. 13, the CDFG includes a node 1301 for performing a calculation “J”; and a node 1302 for performing a calculation “Write”.

These nodes are delimited by a delimiter 1303 and a delimiter 1304. These delimiters are used to determine a boundary between the states. These delimiters are determined to conform with the delimiters of the operation clock of the hardware.

FIG. 14 shows an example of the operation information 206 of each node of the CDFG shown in FIG. 13.

As shown in FIG. 14, node 1301 is an calculation node which performs the calculation “J”, and node 1302 is a node which writes data into the memory. Nodes 1301 and 1302 are both scheduled in state number “n”.

FIG. 15 shows an example of the connection information 207 of each node of the CDFG shown in FIG. 13.

In FIG. 15, node 1301 has two inputs (i.e. input 1 and input 2) and one output. The value stored in register r9 is input to the input 1 of node 1301. The value stored in register r10 is input to the input 2 of node 1301. The output value of node 1301 is output to node 1302. Node 1302 has two inputs (i.e. input 1 and input 2) and no output. The value output from node 1301 is input to the input 1 of node 1302, and this value is used as data to be written into the memory. The value stored in register r11 is input to the input 2 of node 1302, and this value is used as address information used to write data into the memory.

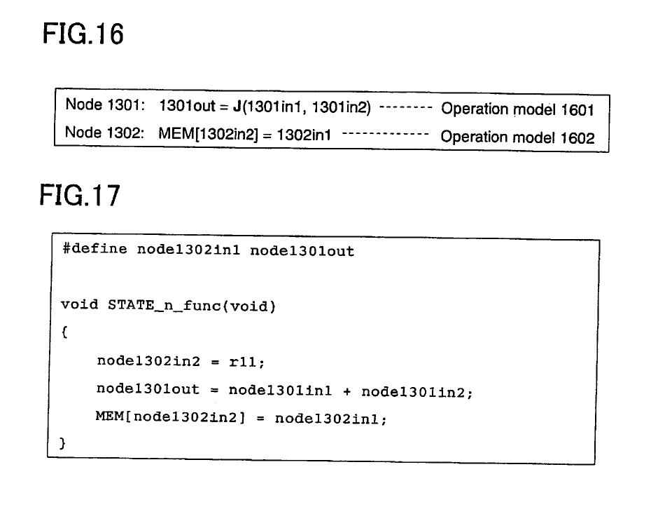

FIG. 16 shows an example of an operation model for each node, which is generated by the operation model generating section 210 shown in FIG. 2 using the operation information 206 of each node shown in FIG. 14.

In FIG. 16, the operation model of node 1301 indicates that the calculation “J” is performed with respect to the input value “1301in1” and the input value “1301in2”. The operation model of node 1302 indicates that the input value “1302in1” is written by “MEM” into the address “1302in2” of a storage device such as a memory.

FIG. 17 shows an example of the C programming language description, which describes the calculation formulae shown in FIG. 16 in the function “STATE_n_func” for the state number n shown in FIG. 13.

In the example shown in FIG. 17, an addition is performed for node 1301. The variables representing the input value and output value of the node are expressed as “node1301in”, “node1301out”. Further, when an output value of a node or a register is used as an input value to a storage device such as a memory, the output value is stored in the memory using the calculation formula of the input value to the storage device such as a memory.

A “MEM” denotes a memory model represented by an array of variables in the C programming language. In the present embodiment, the operation of writing data into the memory is expressed by the substitution of input values for the array of variables. This is based on the assumption that the writing of data into the memory is performed only from a single function block.

The function block is referred to as a block including logic sections which perform a series of operations within the circuit. The function block is generated by the block division section 203 shown in FIG. 2. It is possible to arrange a plurality of function blocks within a single circuit. The plurality of function blocks can be operated in parallel. Therefore, when a plurality of function blocks are arranged within a circuit and the plurality of function blocks perform write operations to the same storage device (e.g. the same memory) in parallel, the write operations can possibly be performed in the same clock cycle. In this case, it may be necessary to arbitrate the write operations of the plurality of function blocks. The arbitration processing for arbitrating the write operations of the plurality of function blocks will be described below.

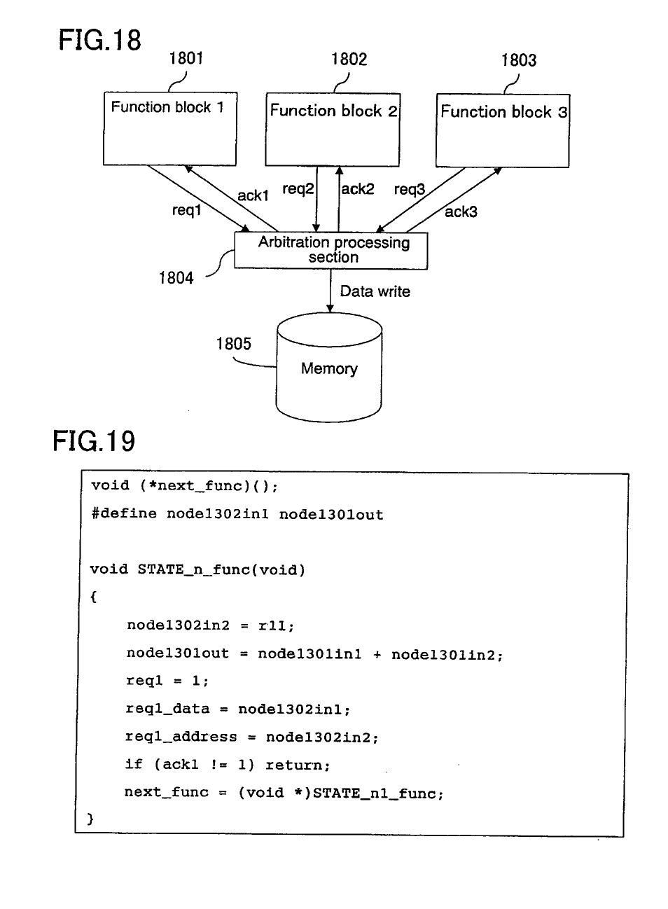

FIG. 18 shows an example of the arbitration processing for arbitrating the write operations of the plurality of function blocks. Each of the write operations is performed to write data into a storage device such as a memory.

In the example shown in FIG. 18, three function blocks 1801, 1802 and 1803, an arbitration processing section 1804 and a memory 1805 are provided. The write operations are performed from the function blocks 1801 to 1803 to memory 1805.

The write operation from function block 1801 is performed by using a request “req1” and an acknowledge “ack1”. The request “req1” is sent from function block 1801 to an arbitration circuit (the arbitration processing section 1804). In response to the request “req1”, the acknowledge “ack1” is sent back from the arbitration processing section 1804 to function block 1801. Similarly, the write operation from function block 1802 is performed by using a request “req2” and an acknowledge “ack2”, and the write operation from function block 1803 is performed by using a request “req3” and an acknowledge “ack3”.

Once the arbitration processing section 1804 receives a request for the write operation, it returns an acknowledge to only one function block which is allowed to perform the write operation. Thus, each of the function blocks can detect the completion of the write operation by receiving the acknowledgement.

FIG. 19 shows an example of the description of the write operation using an operation model of the present embodiment, when the arbitration processing is required to perform the write operation. FIG. 19 is a modified version of FIG. 17.

The calculation foxmulae shown in FIG. 19 are included in the function block 1801 shown in FIG. 18.

As shown in FIG. 19, the value stored in register r11 is input to node 1302 as the input value “1302in2”. In node 1302, the input value “1301in1” is added to the input value “1302in2”. The value of the request “req1” is set to a value of “1” in order to communicate a request for the write operation from the function block 1801 to the arbitration circuit. In node 1302, the input value “1302in1” is written into the storage device such as a memory at the address “1302in2”. When the write operation is completed, the value of the response “ack1” is set to a value of “1” in order to acknowledge the request “req1”. The function indicated by the pointer “next_func” is executed to progress the simulation cycle one by one.

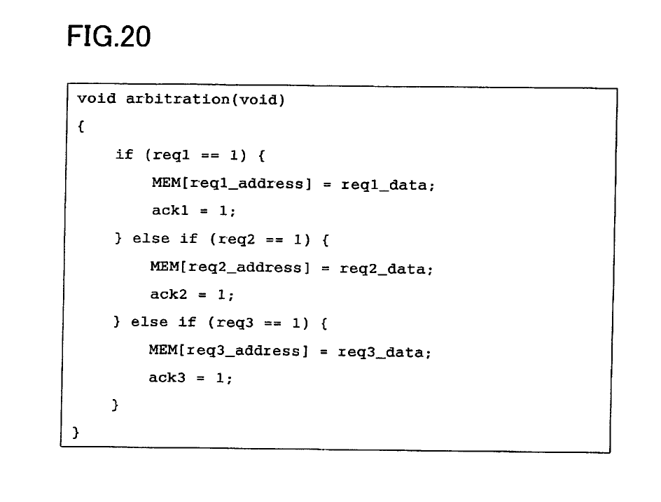

FIG. 20 shows an example of the processing performed by the arbitration processing section 1804 shown in FIG. 18.

As shown in FIG. 20, in the function “arbitration”, it is determined whether or not there exists a write request from each function block (i.e. whether or not the values of “req1” to “req3” are set to “1”), the exclusive access control of the write operation (i.e. control by “if” and “else if”) is performed, and the notification of the completion of the write operation is performed (i.e. the values of “ack1” to “ack3” are set to “1”).

As described above, it is possible to calculate an input value to a storage device such as a memory for each state of the CDFG after the scheduling process is completed, by using the C programming language description shown in FIGS. 17, 19 and 20.

Further, it is possible to simulate the hardware at a cycle accurate level by performing at least one function generated by the cycle accurate model generating section 111, in accordance with the order to be executed, which is obtained as the scheduling result.

Further, it is possible to observe the value of the storage device, which is realized by a memory and so forth, within the hardware at a cycle accurate level by performing an assigning process to the hardware.

As described above, according to the present embodiment, the CDFG is generated by the CDFG generating section 109 based on the operation description of hardware 107, the CDFG is scheduled by the scheduling section 110 at an operation frequency required by the specification of the hardware and is assigned to each state, and the operation model of the hardware is generated by the cycle accurate model generating section 111 for each state as a description represented by a general-purpose programming language. The model which can be simulated for each state is generated by generating the operation model of each node using the operation information of the nodes included in the CDFG, and by determining the order in which the operation model of each node is calculated using the connection information of the nodes. As a result, it is possible to generate a model for verification described in a general-purpose programming language, which is capable of verifying hardware at a cycle accurate level at a lower cost and at a higher speed, with a smaller amount of calculation compared to the conventional method.

As described above, the present invention is exemplified by the use of the preferred embodiments of the present invention. However, the present invention should not be interpreted solely based on the embodiments described above. It is understood that the scope of the present invention should be interpreted solely based on the claims. It is also understood that those skilled in the art can implement equivalent scope of technology based on the description of the present invention and common knowledge from the description of the detailed preferred embodiments of the present invention. Furthermore, it is understood that any patent, any patent application and any references cited in the present specification should be incorporated by reference in the present specification in the same manner as the contents are specifically described therein.

The present invention is useful to provide a programming language model generating apparatus for hardware verification for automatically generating a general-purpose programming language description capable of verifying the hardware, which is used for development and/or design of a system LSI; a programming language model generating method for hardware verification using the apparatus; a computer system; a hardware simulation method using the computer system; a control program for making a computer execute the method; and a computer-readable storage medium having the control program stored thereon. In the fields described above, it is possible to verify the hardware at a cycle accurate level at a lower cost and at a higher speed, compared to the verification by the conventional HDL simulator. Further, when the verification of hardware and software is performed cooperatively, the verification of the hardware can be performed using a model described in a general-purpose programming language. Accordingly, it is possible to efficiently perform the verification at a cycle accurate level without using any debugger in the different language.

According to the present invention, it is possible to improve the efficiency of debugging of the hardware by observing the state of the registers and the storage device within the hardware at an arbitrary clock cycle.

According to the present invention, a model is generated using a control/data flow graph. Accordingly, itis possible to greatly reduce the computing time required for generating an operation model, even when the scale of a circuit becomes large.

As described above, according to the present invention, it is possible to shorten TAT in designing and/or developing an LSI and to reduce the cost required for the development.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A programming language model generating apparatus for hardware verification for automatically generating a general-purpose programming language model capable of verifying a hardware, comprising:
a control data flow graph generating section for generating a control data flow graph of the hardware based on operation information obtained as a result of analyzing an operation description representing operations of the hardware;
a scheduling section for scheduling the control data flow graph using an operating frequency required for the specification of the hardware, and for assigning the control data flow graph to each state; and
a cycle accurate model generating section for generating an operation model of the hardware as a description represented by the general-purpose programming language using the control data flow graph assigned to each state.

2. A programming language model generating apparatus for hardware verification according to claim 1, wherein the cycle accurate model generating section includes:
an operation model generating section for generating an operation model of each of a plurality of nodes included in the control data flow graph using an operation information of each of the nodes, and for determining an order in which the operation model of each of the nodes is calculated using a connection information of each of the nodes, in order to generate a model which can be simulated in each state.

3. A programming language model generating apparatus for hardware verification according to claim 1, wherein the cycle accurate model generating section includes:
a register input value calculation formula generating section for generating a calculation formula used to store an output value of a particular node in the register using a model representing an output result of the particular node, when the output of the particular node is used as an input to another node over the states.

4. A programming language model generating apparatus for hardware verification according to claim 1, wherein the cycle accurate model generating section includes:
a storage device input value calculation formula generating section for generating a calculation formula used to store an output value of a particular node or a register in the storage device using a model representing an output result of the particular node or the register, when the output of the particular node or the register is used as an input to the storage device.

5. A programming language model generating apparatus for hardware verification according to claim 1, wherein the cycle accurate model generating section represents the operation model of the hardware as a model which can be simulated in each state by using at least one function of the general-purpose programming language.

6. A programming language model generating apparatus for hardware verification according to claim 1, wherein the control data flow graph generating section includes:
a syntactic/lexical analysis section for analyzing an operation description describing operations of a process, but not describing any structure of the hardware;
a block division section for dividing a circuit into blocks in accordance with a parallel operation analyzed by the syntactic/lexical analysis section; and
a control data flow graph generating section for generating, for each block, a control data flow graph including nodes each representing a calculation performed by the hardware and a branch representing a flow of data between the nodes.

7. A programming language model generating apparatus for hardware verification according to claim 2, wherein the operation information of each of the nodes includes, for each of the nodes:
information indicating at least whether or not the node represents a calculation, a type of the calculation to be performed when the node represents the calculation, a function of the node when the node does not represent any calculation;
a hierarchal level; and
a state number.

8. A programming language model generating apparatus for hardware verification according to claim 2, wherein the connection information of each of the nodes includes information indicating destinations of the output and the input of the node.

9. A computer system comprising:
a programming language model generating apparatus for hardware verification according to claim 1; and
a simulation section for simulating the hardware by executing at least one function generated by the cycle accurate model generating section, in accordance with an order of the states to be executed, which is obtained as the scheduling result by the scheduling section.

10. A programming language model generating method for hardware verification for automatically generating a general-purpose programming language model capable of verifying a hardware, comprising the steps of:
(a) generating a control data flow graph of the hardware based on operation information obtained as a result of analyzing an operation description representing operations of the hardware;
(b) scheduling the control data flow graph using an operating frequency required for the specification of the hardware, and for assigning the control data flow graph to each state; and
(c) generating an operation model of the hardware as a description represented by the general-purpose programming language using the control data flow graph assigned to each state.

11. A programming language model generating method for hardware verification according to claim 10, wherein the step (c) includes the step of:
generating an operation model of each of a plurality of nodes included in the control data flow graph using an operation information of each of the nodes, and for determining an order in which the operation model of each of the nodes is calculated using a connection information of each of the nodes, in order to generate a model which can be simulated in each state.

12. A programming language model generating method for hardware verification according to claim 10, wherein the step (c) includes the step of:
generating a calculation formula used to store an output value of a particular node in the register using a model representing an output result of the particular node, when the output of the particular node is used as an input to another node over the states.

13. A programming language model generating method for hardware verification according to claim 10, wherein the step (c) includes the step of:
generating a calculation formula used to store an output value of a particular node or a register in the storage device using a model representing an output result of the particular node or the register, when the output of the particular node or the register is used as an input to the storage device.

14. A programming language model generating method for hardware verification according to claim 10, wherein the step (c) includes the step of:
representing the operation model of the hardware as a model which can be simulated in each state by using at least one function of the general-purpose programming language.

15. A programming language model generating method for hardware verification according to claim 10, wherein the step (a) includes the steps of:
analyzing an operation description describing operations of a process, but not describing any structure of the hardware;
dividing a circuit into blocks in accordance with a parallel operation analyzed by the syntactic/lexical analysis section; and
generating, for each block, a control data flow graph including nodes each representing a calculation performed by the hardware and a branch representing a flow of data between the nodes.

16. A hardware simulation method comprising:
the steps of the programming language model generating method for hardware verification according to claim 10; and
a simulation step of simulating the hardware by executing at least one function generated in the step (c), in accordance with an order of the states to be executed, which is obtained as the scheduling result in the step (b).

17. A control program for making a computer execute the steps of the method according to claim 10.

18. A computer-readable storage medium having stored thereon the control program according to claim 17.
